(19) United States
(12) Patent Application Publication
(10) Pub. No.: US 2015/0159079 A1
(43) Pub. Date: Jun. 11, 2015

(54) METHODS AND COMPOSITIONS FOR CONFORMANCE CONTROL USING TEMPERATURE-TRIGGERED POLYMER GEL WITH MAGNETIC NANOPARTICLES

(71) Applicant: Board of Regents, The University of Texas System, Austin, TX (US)

(72) Inventors: Chun Huh, Austin, TX (US); Krishna K. Panthi, Austin, TX (US); Kishore K. Mohanty, Austin, TX (US); Steven L. Bryant, Austin, TX (US)

(21) Appl. No.: 14/563,572

(22) Filed: Dec. 8, 2014

Related U.S. Application Data
(60) Provisional application No. 61/914,156, filed on Dec. 10, 2013.

(51) Int. Cl. C09K 8/588; C09K 8/592; E21B 47/06; E21B 41/00; E21B 43/16; E21B 47/00

(52) U.S. Cl. CPC C09K 8/588; E21B 43/16; E21B 47/00; E21B 47/0002; E21B 47/06; E21B 47/065; E21B 41/0092; C09K 8/592; C09K 2208/10

(57) ABSTRACT

The present disclosure provides a polymer gel and method of making and using the same for use in high-permeability layers. This precision conformance control is accomplished by using paramagnetic nanoparticles and the application of the magnetic oscillation of prescribed frequency at the wellbore. If the polymer gel were created unintentionally at a certain layer, or there is a need to remove the gel blockage at the later stage of oil production, the gel could be broken and removed to restore the productivity from the layer.

### CROSS-REFERENCE TO RELATED APPLICATIONS

This application claims priority to U.S. Provisional Application Ser. No. 61/914,156 filed Dec. 10, 2013, the entire contents of which are incorporated herein by reference.

### TECHNICAL FIELD OF THE INVENTION

The present invention relates generally to methods and compositions used for enhanced oil recovery and more particularly to methods and compositions for conformance control in heterogeneous oil reservoirs, by using temperature-triggered polymer gel together with magnetic nanoparticles.

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

Without limiting the scope of the invention, its background is described in connection with methods and compositions for conformance control, using polymer gels that contain magnetic nanoparticles.

The excessive production of water or gas from oil wells is one of the major production difficulties in the petroleum industry. Although a wide variety of techniques are available to remedy the problem, the choice of a specific method to reduce water or gas production depends on the type of reservoir wells.

When water or an enhanced oil recovery (EOR) fluid is injected into a heterogeneous reservoir to displace oil, more of the injectant goes to the high-permeability layer and produces oil from the layer. With the oil removed, the effective permeability of the high-permeability layer becomes even higher, and virtually all of the fluid subsequently injected goes to the high-permeability layer, with the consequence that the oil still left in the lower-permeability layers is entirely bypassed. Various techniques have been employed to divert the injected fluid to the low-permeability layers, so that the bypassed oil there could be produced. These techniques are generally called “conformance control” methods, the most prominent of which is the use of polymer gels to block the high-permeability layers. One critical weakness of the gel-based conformance control method is that, when a polymer and a crosslinker chemical to generate a gel in-situ is injected into a reservoir formation, it goes not only into the high-permeability layer but also into the low-permeability layer. For this reason, a successful conformance control is difficult to achieve.

U.S. Pat. No. 8,466,093, entitled, “Thermoset Nanocomposite Particles, Processing for Their Production, and Their Use in Oil and Natural Gas Drilling Applications,” discloses two methods to enhance the stiffness, strength, maximum possible use temperature, and environmental resistance of thermoset polymer particles in the construction, drilling, completion and/or fracture stimulation of oil and natural gas wells. One method is the application of post-polymerization process steps (and especially heat treatment) to advance the curing reaction and to thus obtain a more densely crosslinked polymer network. The other method is the incorporation of nanofillers, resulting in a heterogeneous “nanocomposite” morphology.

U.S. Pat. No. 8,053,394, entitled, “Drilling Fluids with Redispersible Polymer Powders,” discloses a drilling fluid with a redispersible polymer powder introduced as a water dispersion that is capable of providing a deformable latex film on at least a portion of a subterranean sand formation and which inhibits or controls fluid loss and acts as a sealing agent when used to drill in sand formations for hydrocarbon recovery operations. The redispersible polymer powder may be made by drying the emulsion in which they are formed and then grinding into a powder or by spray drying. The polymer particles of suitable size precipitate or collect or assemble onto the pores of a subterranean sand formation to at least partial seal the formation with a deformable polymer film.

U.S. Pat. No. 7,703,516, entitled, “Stimulating oilfields using different scale-inhibitors,” discloses oilfields stimulated by injecting an inflow stream of a fluid into an oil producing well linked to the oilfield, displacing the oil and recovering an outflow stream of fluid comprising the oil, wherein at least two streams are injected into at least two production zones of an oil well or are injected into at least two different oil producing wells from which at least two outflow streams from the two zones or wells are combined before recovering, with a scale inhibitor having detectable moieties being introduced into the oilfield(s) and/or into the fluid, and wherein two different scale inhibitors are used, dedicated to the two zones or wells, said different scale inhibitors having different detectable moieties that can be distinguished by analysis.

U.S. Pat. No. 7,527,103, entitled, “Procedures and Compositions for Reservoir Protection,” discloses a flow conduit having at least one orifice is placed in the vicinity of a flow source, which in one non-limiting embodiment may be a hydrocarbon reservoir. The flow pathway between the orifice and the source is temporarily blocked with a degradable barrier. Once the flow pathway is physically placed, the degradable barrier is removed under the influence of an acid, a solvent, time and/or temperature. The flow source and the flow pathways are at least partially covered (and flow blocked by) a temporary coating such as a pseudo-filter cake formed by a viscoelastic surfactant-gelled aqueous drill-in fluid, and the flow conduit is extended to the flow source. The pseudo-filter cake is removed when viscosity is reduced by an internal breaker, and flow is then allowed. The method is useful in one context of recovering hydrocarbons where the flow conduit is a telescoping sleeve or tube that contacts the borehole wall.

### SUMMARY OF THE INVENTION

When an enhanced oil recovery (EOR) fluid is injected into a heterogeneous reservoir to displace oil, more of the injectant goes to the high-permeability layer and produces oil from the layer. As the oil is removed from the high-permeability layer, virtually all of the fluid subsequently injected bypasses the lower-permeability layers which still contain oil. Various techniques are employed to divert the injected fluid to the low-permeability layers, so that the bypassed oil could be recovered. The most prominent among these “conformance control” methods is the use of polymer gels to block the high-permeability layers. However, one critical weakness of the gel-based conformance control method is that, when a gel bank (or a polymer and a crosslinker chemical to generate a gel in-situ) is injected into a reservoir formation, it goes not only into the high-permeability layer (for which the gel is intended) but also into the low-permeability layer.

The present disclosure provides a method that forms the polymer gel only in the high-permeability layer and not in the low-permeability layer. This “precision conformance control” is accomplished by using paramagnetic nanoparticles: First, the high-permeability layers from which oil has been displaced and the low-permeability layers in which oil still remains are identified by measuring the magnetic susceptibility of the paramagnetic nanoparticles injected. Second, the magnetic oscillation of prescribed frequency is applied at the high-permeability zone at the wellbore, so that the polymer gel is formed only at the high-permeability layers. If the polymer gel were created unintentionally at a certain layer, or there is a need to remove the gel blockage at the later stage of oil production, the gel could be broken and removed to restore the productivity from the layer.

In order to treat the undesirable, early production of water or gas through high-permeability channels during oil production, polymer gels are frequently employed to block off the problem zone; however, blocking only the high-permeability layers, not the still oil-containing low-permeability layers, is difficult to achieve. The present disclosure provides a novel way of solving the problem, utilizing the temperature-dependent gelling kinetics and the localized heating with use of paramagnetic nanoparticles. The effects of temperature on the gelation kinetics were investigated with various polymers that are cross-linked with chromium acetate and/or polyethyleneimine (PEI). The gelling behavior was studied as a function of temperature, pH and salt type. The effect of iron oxide nanoparticles for gelation was also studied. The gel was not formed with polymer-chromium acetate system after adding iron oxide-nanoparticle (Fe₃O₄—NP) but the gel was formed for polymer-PEI system even after adding Fe₃O₄—NP. Mixtures of polymer, crosslinker and nanoparticles were subjected to a magnetic field oscillation of a given frequency, which resulted in their heating and consequent gel formation.

The present disclosure provides a method for selectively blocking high-permeability layers of a subterranean formation, thereby diverting the subsequently injected EOR fluids into low-permeability layers. This is achieved by injecting into the wellbore a selective conformance control polymer solution that goes into the high-permeability layer at a much higher flow rate than into the low-permeability layer, wherein the polymer in the high-permeability layer is subsequently induced to form gel, and the polymer in the low-permeability layer is retrieved back from it. The selective conformance control polymer solution comprises one or more polymers, a crosslinking agent, and paramagnetic nanoparticles; flowing selectively the selective conformance control polymer solution into the high-permeability layer; applying a magnetic field to the selective conformance control polymer solution to stimulate the paramagnetic nanoparticles to generate heat; crosslinking the one or more polymers and the crosslinking agent to form a selective conformance control gel to block the high-permeability layer.

The one or more polymers and crosslinking agent in the wellbore may be below the critical temperature, above which cross-linking occurs. The paramagnetic nanoparticles may be superparamagnetic nanoparticles, e.g., having an iron oxide (Fe₃O₄) core. The effective diameter of the superparamagnetic nanoparticles may be between 7 and 100 nm. The superparamagnetic nanoparticles may further have a hydrophilic coating, a hydrophobic coating or a coating with a hydrophilic-hydrophobic balance. The magnetic field may be applied using a magnetic oscillation generator and the magnetic field may be with an alternating frequency range of between about 300-1200 kHz; and some specific examples may be about 390, 540, or 920 kHz.

The uncrosslinked mixture from the unheated, low-permeability layer may be removed by a flow-back method. In addition, the paramagnetic nanoparticles may function as a contrast agent allowing the identification of the high-permeability layer by detecting them with electromagnetic logging tools. In addition, the process may also include the step of decomposing the selective conformance control gel by applying magnetic oscillation of the paramagnetic nanoparticles or by thermal degradation induced by the paramagnetic nanoparticles.

In one embodiment, the present invention includes a method for enhanced oil recovery by improving reservoir volumetric sweep, comprising the steps of: injecting into the wellbore a selective conformance control polymer solution with a viscosity that provides a much higher flow rate according to their permeability-thickness distribution into the high-permeability layer than into the low-permeability layer, wherein the selective conformance control polymer solution comprises one or more polymers, a crosslinking agent, and paramagnetic nanoparticles; identifying the locations of the high-permeability layers by measuring the relative amount of paramagnetic nanoparticles in the reservoir layers, by way of the magnetic susceptibility measurement; applying a magnetic field to the selective conformance control polymer solution to stimulate the paramagnetic nanoparticles to generate heat in the high-permeability layers; crosslinking the one or more polymers and the crosslinking agent to form a selective conformance control gel to block the high-permeability layer; and removing the un-crosslinked polymer from the low-permeability layers, so that they could serve as new flow pathways for the injected fluids or produced fluids that are diverted from the now blocked, high-permeability layers. In one aspect, the one or more polymers and crosslinking agent in the wellbore are below the critical temperature above which cross-linking occurs. In another aspect, the one or more polymers comprises polyacrylamide, hydrolyzed polyacrylamide, polyacrylamides with n-vinyl pyrrolidone (NVP) side chains, polyacrylamides with 2-acrylamido 2-methyl propane sulfonate (AMPS) side chains, polyacrylamides with NVP and AMPS side chains, polysaccharide, polyacrylates, polybutylacrylates, polysaccharides such as methylcellulose, hydroxypropyl methylcellulose, curdlan, and xanthan, or their combinations. In another aspect, the crosslinking agent comprises a metallic cross-linker, organic cross-linker or both. In another aspect, the crosslinking agent comprises polyethyleneimine, chromium acetate, aluminum citrate, sodium dichromate, and zirconium lactate. In another aspect, the nanoparticles used for heating are superparamagnetic nanoparticles. In another aspect, the paramagnetic nanoparticles comprise an iron oxide (Fe₃O₄, or magnetite) core. In another aspect, the paramagnetic nanoparticles are between 7 and 100 nm. In another aspect, the paramagnetic nanoparticles further comprises a hydrophilic coating, a hydrophobic coating or an intermediate-wettability coating. In another aspect, the magnetic field is applied using a magnetic oscillation generator. In another aspect, the magnetic field is a high frequency alternating magnetic field. In another aspect, the magnetic field provides an alternating frequency range of between about 300-1200 kHz. In another aspect, the magnetic field provides an alternating frequency range of about 390, 540, or 920 kHz. In another aspect, the method further comprises the step of decomposing the selective conformance control gel by applying magnetic oscillation of the paramagnetic nanoparticles. In another aspect, the method further comprises the step of decomposing the selective conformance control gel by thermal degradation induced by the paramagnetic nanoparticles. In another aspect, the method further comprises the step of removing the uncrosslinked mixture from the unheated, low-permeability layer by a flow-back method. In another aspect, the paramagnetic nanoparticles function as a contrast agent allowing the identification of the high-permeability layer by detecting them with electromagnetic logging tools. In another aspect, the method further comprises the step of imaging the high-permeability layer by detecting the paramagnetic nanoparticles with an electromagnetic logging tool. In another aspect, the method further comprises the step of modifying the amount of salts depending on the temperature to modify the viscosity of the polymer. In another aspect, the method further comprises the step of modifying the amount of at least one of NaCl, or CaCl2 to modify the viscosity of the polymer. In another aspect, the polymer is self-gelling. In another aspect, the cross-linking of the polymer occurs in the presence of one or more salts that are provided at 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 4.0, 5.0, 6.0, 7.0, or 8.0 weight percent. In another aspect, the method further comprises the step of removing the magnetic field to release the polymer.

In another embodiment, the present invention includes a method for enhanced oil recovery by improving reservoir volumetric sweep, comprising the steps of: selecting a polymer and paramagnetic nanoparticles to make a control polymer solution for injection into the high-permeability layer than into the low-permeability layer depending on the temperature and pressure characteristics of a formation; injecting into the wellbore a selective conformance control polymer solution with a viscosity that provides a much higher flow rate according to their permeability-thickness distribution into the high-permeability layer than into the low-permeability layer, wherein the selective conformance control polymer solution comprises one or more polymers, a crosslinking agent, and paramagnetic nanoparticles; identifying the locations of the high-permeability layers by measuring the relative amount of paramagnetic nanoparticles in the reservoir layers, by way of the magnetic susceptibility measurement; applying a magnetic field to the selective conformance control polymer solution to stimulate the paramagnetic nanoparticles to generate heat in the high-permeability layers; crosslinking the one or more polymers and the crosslinking agent to form a selective conformance control gel to block the high-permeability layer; and removing the un-crosslinked polymer from the low-permeability layers, so that they could serve as new flow pathways for the injected fluids or produced fluids that are diverted from the now blocked, high-permeability layers. In one aspect, the method further comprises the step of releasing the magnetic field to release the polymer.

In another embodiment, the present invention also includes a method for enhanced oil recovery by improving reservoir volumetric sweep and removing the polymer if necessary, comprising the steps of: selecting a polymer and paramagnetic nanoparticles to make a control polymer solution for injection into the high-permeability layer than into the low-permeability layer depending on the temperature and pressure characteristics of a formation; injecting into the wellbore a selective conformance control polymer solution with a viscosity that provides a much higher flow rate according to their permeability-thickness distribution into the high-permeability layer than into the low-permeability layer, wherein the selective conformance control polymer solution comprises one or more polymers, a crosslinking agent, and paramagnetic nanoparticles; identifying the locations of the high-permeability layers by measuring the relative amount of paramagnetic nanoparticles in the reservoir layers, by way of the magnetic susceptibility measurement; applying a magnetic field to the selective conformance control polymer solution to stimulate the paramagnetic nanoparticles to generate heat in the high-permeability layers; crosslinking the one or more polymers and the crosslinking agent to form a selective conformance control gel to block the high-permeability layer; removing the un-crosslinked polymer from the low-permeability layers, so that they could serve as new flow pathways for the injected fluids or produced fluids that are diverted from the now blocked, high-permeability layers; releasing the magnetic field to reduce the viscosity of the polymer; and removing the polymer from the reservoir.

### BRIEF DESCRIPTION OF THE DRAWINGS

For a more complete understanding of the features and advantages of the present invention, reference is now made to the detailed description of the invention along with the accompanying figures and in which:

FIG. 1A schematically shows the different invasion extents of the injection polymer and nanoparticle mixture into the high-permeability and low-permeability layers, and the detection of the different invasion extents by the magnetic sensor. FIG. 1B schematically shows the “hyperthermia” heating of the high-permeability layers to form the gel.

FIG. 2 is the relation between the total volume magnetic susceptibility and the concentration of superparamagnetic nanoparticles dispersed in de-ionized water, for different frequencies with the applied magnetic field strength of 320 A/m, as measured with magnetic susceptibility meter.

FIG. 3 is the relation between the total volume magnetic susceptibility and the concentration of superparamagnetic nanoparticles dispersed in decane, for different frequencies with the applied magnetic field strength of 320 A/m, as measured with magnetic susceptibility meter.

FIG. 4A is a top view and FIG. 4B is a side view showing the batch dispersion sample loading within coil at a relative point of (0,0). FIG. 4C shows the sample holder placed within the magnetic coil for static SAR studies.

FIG. 5 shows the measured SAR values for 10.5 wt % hydrophobic magnetite nanoparticles dispersed in hexane at varying magnetic fields and frequencies.

FIG. 6 shows the measured SAR values for 10 wt % hydrophilic magnetite nanoparticles in water at varying magnetic fields and frequencies.

FIG. 7 shows gel formation of SAV505; left having no divalent ions and right having divalent ions.

FIGS. 8A and 8B show the gelling time versus temperature for SAV505; FIG. 8A with NaCl and FIG. 8B with NaCl and divalent ions, as seen in FIG. 7.

FIG. 9 shows viscosity measurement at room temperature.

FIG. 10 shows the formation of gel for 2000 ppm of HPAM and 5 wt % PEI; left with iron-oxide nanoparticles, and right with no nanoparticles.

FIG. 11 shows the formation of methyl cellulose (MC) gel. From left to right in each photo: (tube 1) 1.5% MC; (tube 2) 1% MC; (tube 3) 1.5% MC+8% NaCl+2% CaCl₂; (tube 4) 1% MC+8% NaCl+2% CaCl₂ and (tube 5) 1.5% MC+8% NaCl+2% CaCl₂+0.28 wt % Fe₃O₄—NP.

FIG. 12 shows the formation of methyl cellulose (MC) gel with different nanoparticles with different surface coating. (From left to right: synthesized nanoparticles with coating of PAA100K, PAA450K and APTES; and EMG 700 and EMG 605).

FIG. 13 shows the formation of hydroxypropyl methylcellulose (HPMC) gel. From left to right in each photo: (tube 1) 2% HPMC; (tube 2) 1% HPMC; (tube 3) 2% HPMC+8% NaCl+2% CaCl₂; and (tube 4) 1% HPMC+8% NaCl+2% CaCl₂.

FIG. 14 shows the formation of hydroxypropyl methylcellulose (HPMC) gel: left: 1% HPMC+8% NaCl+2% CaCl₂+0.28% Fe₃O₄; and right: 1% HPMC+8% NaCl+2% CaCl₂).

FIG. 15 shows the formation of curdlan gel. In each picture, from left to right: (a) 6% curdlan; (b) 6% curdlan+8% NaCl+2% CaCl_{2;} and (c) 6% curdlan+2% NaCl).

FIG. 16 shows the formation of curdlan gel demonstrated with the tubes that are inverted: Left: 6% curdlan+1% NaCl+1% CaCl₂+0.28% Fe₃O₄ NP; Center: 6% curdlan+0.28% Fe₃O₄ NP; and Right: 6% curdlan.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The disclosure provides method and compositions that form a polymer gel only in the high-permeability layer and not in the low-permeability layer. The disclosure provides the injection of a small bank of a mixture of polymer that can be crosslinked to form a gel using a crosslinker and paramagnetic nanoparticles, into a reservoir formation at a well. The mixture has an almost water-like viscosity and will flow into different layers of reservoir at different rates according to their permeability-thickness distribution. Thus, more of the mixture will go into the high-permeability layers which need to be blocked, rather than the low-permeability layers. The polymers and crosslinkers are selected in such a way that the reservoir temperature will be below the critical temperature above which cross-linking occurs.

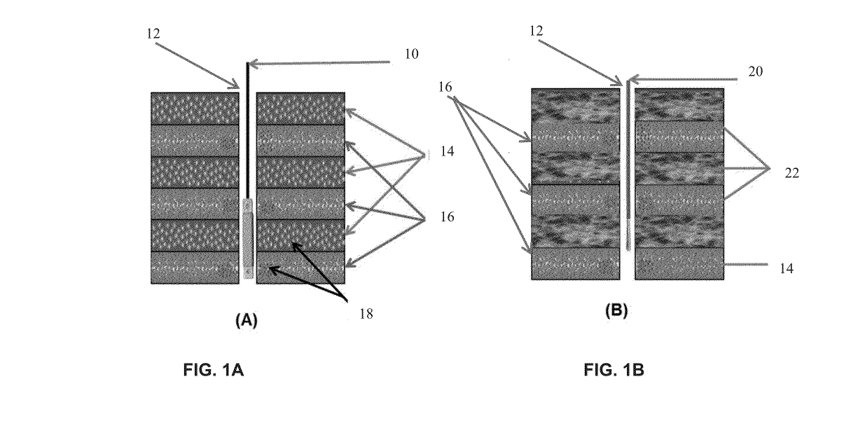

The disclosure provides method of using superparamagnetic nanoparticles at the near-wellbore zone and a magnetic induction generator-receiver logging tool that can be run vertically along the wellbore, to measure the extent of the injectant mixture's invasion, into the different layers of the reservoir. FIG. 1A shows schematically that, when a mixture of polymer and nanoparticles are injected into a reservoir, their invasion extent is different for the high-permeability and low-permeability layers. The different invasion extents can be quantified by measuring the vertical distribution of the magnetic nanoparticles with the magnetic sensor. FIG. 1A shows the insertion of the magnetic sensor 10 into well 12 and shows alternating high-k layers 14 and low-k layers 16 as well as the un-gelled solution 18. The disclosure identifies zones that need to be blocked, i.e., the layers with the most invasion of the injectant, and method of using a magnetic oscillation generator that is lowered into the well and will selectively heat up the paramagnetic nanoparticles (by the “hyperthermia” method) in the layers that need to be blocked. The localized heating will trigger the crosslinking of the polymer, thereby blocking the layer with the newly generated gel. FIG. 1B shows schematically the “hyperthermia” heating of the magnetic nanoparticles in the high-permeability layers, thereby creating a polymer gel in the high-permeability layers. FIG. 1B shows the insertion of the magnetic heater 20 into well 12 such that gel 22 is formed between low-k layers 16,

The disclosure provides a “flow-back” of the injected mixture, thereby removing the un-crosslinked mixture from the unheated, low-permeability layers while the polymer gel formed in the high-permeability layers will stay there.

In addition, if the polymer gel is created unintentionally at a certain layer, or there is a need to remove the gel blockage at the later stage of oil production, the gel there can be broken by applying more magnetic oscillation locally, so that the gel can be broken by thermal degradation.

In addition to their use as an efficient heating medium, to trigger the crosslinking of polymer for gel formation, the paramagnetic nanoparticles of the disclosure can be used as “contrast agent”, allowing the identification of the high-permeability layers, by detecting them with electromagnetic logging tools, such as magnetic susceptibility logging tool.

In addition, the paramagnetic nanoparticles of the disclosure can be used by employing the hyperthermia technique that uses paramagnetic nanoparticles and external magnetic oscillation of a prescribed frequency, to heat a highly localized area of the near-wellbore zone, thereby triggering the polymer gel formation only in the high-permeability layers.

In addition, the un-crosslinked polymer from the low-permeability layers can be removed, ensuring that the subsequently injected fluid goes only into the low-permeability layers.

With the disclosed “precision conformance control” method, the unintended blockage of the low-permeability layers by the gel can be prevented. Because virtually all oil reservoirs have the conformance problem, its precision treatment can bring significant operational and economic benefits in optimally managing oil reservoirs for maximum oil production.

The effectiveness of the magnetic oscillation generation that is confined to the high-permeability layer has not been fully quantitative, even though the hyperthermia heating of different liquids using paramagnetic nanoparticles has been studied and demonstrated. By carrying out numerical simulations of the magnetic field distribution at the near-wellbore zone, the optimum size of magnetic coil and its location at well, to achieve the desired heating results, can be determined. The technique can also be employed to remedy the water breakthrough problem at the production wells which have multiple hydraulic fractures.

In support of this application, the details are described in the following four parts below: (1) Determination of the amount of the superparamagnetic nanoparticles dispersed in liquid by measuring the magnetic susceptibility non-invasively; (2) demonstration of the nanoparticles' ability to heat quickly the liquid in which they are dispersed; (3) demonstration of the dependence of the gel formation on temperature, so that the temperature increase by quick, localized heating can be utilized for the formation of gel only in a confined volume; and (4) demonstration of gel formation from the mixture of polymer, crosslinker and superparamagnetic nanoparticles, with application of magnetic oscillation of a prescribed frequency.

Determination of the Concentration of Paramagnetic Nanoparticles Dispersed in Liquid. In the geoscience discipline of paleomagnetism, the minute amount of the magnetic minerals in the rock is quantified by measuring the effective magnetic susceptibility of the rock, and is employed to estimate the formation history and other properties of the reservoir zone. In a similar manner, the concentration of paramagnetic nanoparticles dispersed in a liquid, such as water, can be easily determined by measuring the effective magnetic susceptibility (χ) of the dispersion, because the susceptibility is related to the volume fraction of the nanoparticles by the following equation:

$$χ ≡ \frac{M}{H} = \frac{{πφμ}_{o} {M}_{d}^{2} {d}^{3}}{18 kT} \qquad ( 1 )$$

where φ is volume fraction of the nanoparticles; μₒ is vacuum permeability; M_{d} is bulk magnetization of the nanoparticle solid; d is nanoparticle diameter; k is the Boltzman constant; and T is absolute temperature.

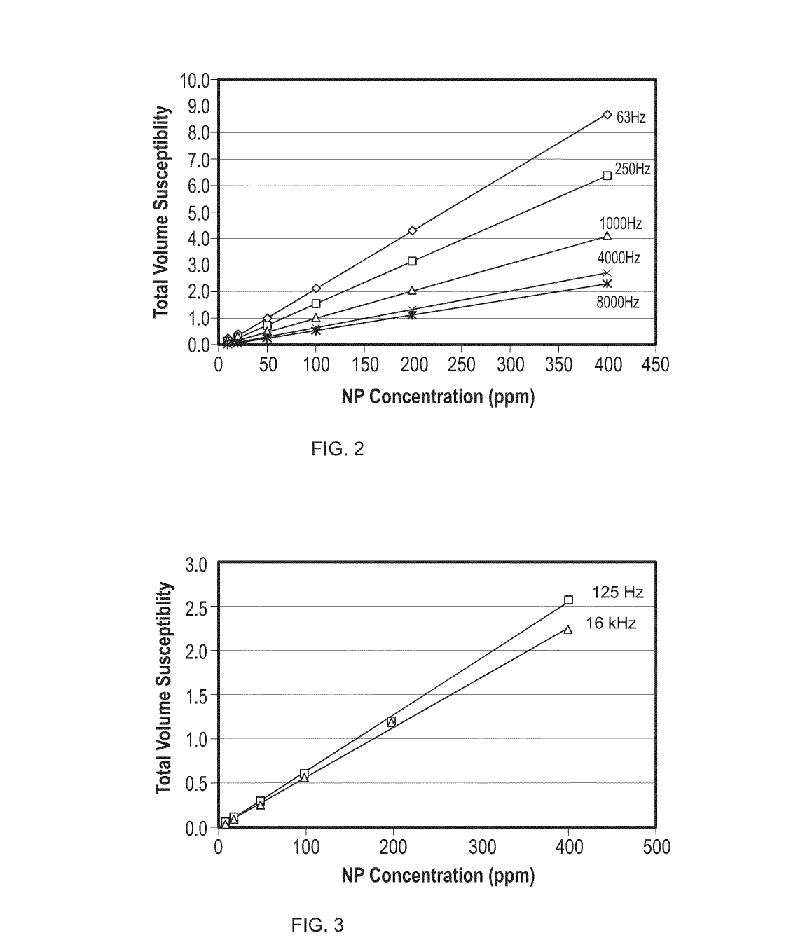

The above Equation (1) is for very dilute dispersions; and in practice, a calibration curve is prepared for the particular combination of the nanoparticle and the dispersing liquid, which is subsequently employed to determine the nanoparticle concentration in the dispersion sample. FIG. 2 shows example calibration curves, i.e., the relation between the total volume susceptibility and the concentration nanoparticles dispersed in de-ionized water, for different frequencies with the applied magnetic field strength of 320 A/m. The nanoparticles used were iron-oxide-core superparamagnetic nanoparticles with hydrophilic coating (EMG700), as described below. FIG. 3 shows example calibration curves, i.e., the relation between the total volume susceptibility and the concentration nanoparticles dispersed in decane, for different frequencies with the applied magnetic field strength of 320 A/m. The nanoparticles used were iron-oxide-core superparamagnetic nanoparticles with hydrophobic coating (EMG1400), as described below. The SM-100 Portable Magnetic Susceptibility Meter (ZH Instruments) was employed for the measurements.

The above figures demonstrate that the paramagnetic nanoparticles injected into the reservoir formation, together with the polymer and crosslinker, can be detected with the magnetic susceptibility measuring tool inserted into the wellbore. The development and use of such magnetic susceptibility well-logging system has been reported in the literature (Scott et al., 1981; Nowaczyk, 2001), which can be utilized for the present purpose.

Heating of Liquid Using Paramagnetic Nanoparticles Dispersed in It: Relevant Theory. The present invention provides nanoparticles that can be used to heat a material containing the particles or a material brought into contact with the particles when exposed to a high frequency alternating magnetic field. Superparamagnetic nanoparticles were used which exhibit Neel relaxation as the primary mode of heating at the frequencies, as demonstrated by Rosensweig (2002). When an external magnetic field is applied to a superparamagnetic nanoparticle dispersion, the particles' internal magnetic moments align with the applied field; and then when the field is turned off, the moments revert to random orientations. The reorientation of the moment requires a characteristic time known as the Neel relaxation time, τ_{N}, as given by Hergt et al. (2003):

$${τ}_{N} = {τ}_{o} exp ( \frac{KV}{{k}_{B} T} ) \qquad ( 2 )$$

where τₒ=10⁻⁹ s, k_{B} is the Boltzmann constant, T is temperature (in Kelvin), K is the magnetic anisotropy energy density, and V=πd_{c}³/6 is the volume of the particle core (i.e., excluding surface coating).

In addition to Neel relaxation, the other relaxation mode is the Brownian relaxation, which involves the rotation of the particle itself. Previous research has shown that Neel relaxation is the exclusive relaxation mode at frequencies higher than 100 kHz (Hergt et al., 2003), and is effective for heat generation. Neel relaxation passes through a “specific loss” maximum around 1 GHz due to ferromagnetic resonance as demonstrated by Fannin et al. (1999). As described below, the “specific loss” represents the amount of energy generated per unit mass of particles. Neel relaxation heating is especially useful because it relies on a mechanism internal to the nanoparticles, i.e., they do not need to move in order to generate heat. The present disclosure provides suitable nanoparticles that can still generate heat effectively while being embedded in a very viscous liquid or a solid, such as the polymer gel created to block the high-permeability layer.

Rosensweig (2002) provides a power equation which predicts the energy dissipated by the nanoparticles when subjected to the oscillating magnetic field. Rosensweig derives the change in internal energy of the system based on the magnetic work done on the system:

$$Δ U = - {μ}_{o} \int • MdH = 2 {μ}_{0} {H}_{0}^{2} {χ}^{″} {\int }_{0}^{2 π / ω} {sin}^{2} ω t d t \qquad ( 3 )$$

where μₒ is the magnetic permeability of free space [4π*10⁻⁷], M is the magnetization; and H is the magnetic field strength; H₀ is the maximum magnetic field strength; and χ″ is the out-of-phase component of the magnetic susceptibility (also known as the “loss” component), which depends significantly on τ_{N}. Integration and multiplication by the cyclic frequency (f) yields the power dissipated in terms of the magnetic properties of the system, and the loss component:

P=fΔU (4)

Rosensweig further manipulates the power dissipation in terms of the magnetic nanoparticle properties. Equation (5), below, is a slightly modified form, due to Rovers et al. (2009), to estimate theoretically the expected energy gained by fluids in contact with the nanoparticles:

$$\begin{matrix}P = \frac{2 {( π mHf {τ}_{N} )}^{2}}{{τ}_{N} {k}_{B} TV ( 1 + {( 2 π f )}^{2} {τ}_{N}^{2} )} & ( 5 ) \\ m = \frac{{πμ}_{0} {M}_{b} {d}_{c}^{3}}{6} & ( 6 )\end{matrix}$$

where m is the magnetic moment of the particles [A m²], and M_{b} is the magnetization of the particles [A/m]. The energy dissipated by the particles has a cubic dependence on the magnetite core diameter, so small variations in particle diameter can cause large differences in the amount of heat generated. The energy dissipated by the particles is linearly dependent on frequency up to about 1 GHz, and quadratically dependent on the magnetic field strength.

Heat transfer is another important factor in nanoparticle heating. The particles are always in direct contact with the fluid to be heated, or embedded in a polymer gel which may require further heating. Thus, heat transfer from the nanoparticle to the surrounding medium plays a vital role. The present disclosure provides nanoparticle heating resulting from varying magnetic field strengths and different frequencies. One embodiment of the instant disclosure provides placing a sample at the location of maximum magnetic field strength where it is assumed that the field is acting uniformly.

Heating of Liquid Using Paramagnetic Nanoparticles Dispersed in It. To demonstrate that the application of magnetic oscillation of a prescribed frequency to the paramagnetic nanoparticles is an efficient way of quickly raising the temperature of the dispersing liquid, a set of heating experiments were carried out. The magnetic nanoparticles used were purchased from a commercial supplier Ferrotec, (Germany). Particles with both hydrophilic and hydrophobic coatings were purchased to determine if particle coating and solvent properties affect particle heating behavior. The particles have an iron oxide core, Fe₃O₄ or magnetite, and the core diameter for both types of particles was said to be 10 nm, although others have reported that the core size is in the range 12.1±3.0 nm (Rovers et al., 2009). Particles with a hydrophilic coating, EMG700, were dispersed in water for heating capability characterization and particles with a hydrophobic coating, EMG1400, were dispersed in hexane for similar characterization. Using a uniformly stable dispersion is important; suspension homogeneity ensures that the liquid to be heated is loaded with the prescribed nanoparticle weight percentage. The hydrophilic nanoparticles disperse well in water with no sedimentation problem, and the hydrophobic particles disperse reasonably well (˜5 minute suspension times prior to mild sedimentation, which is sufficient for the short duration heating) in hexane. Tetrahydrofuran (THF) and toluene were also found to be a very good solvent for dispersing the hydrophobic nanoparticles.

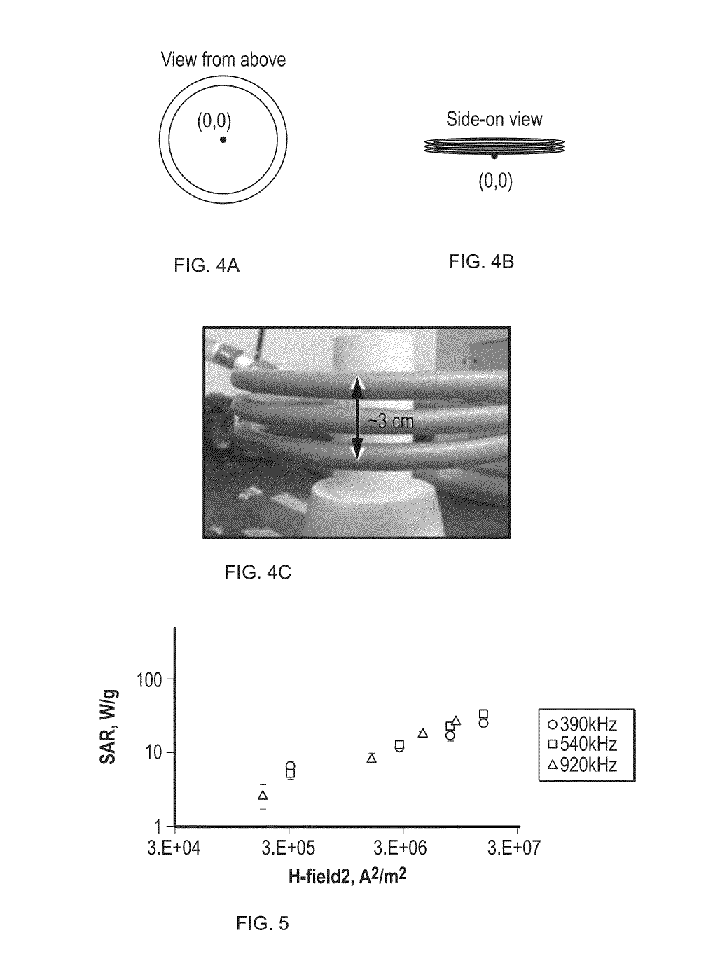

FIG. 4A is a top view and FIG. 4B is a side view of the 3-turn magnetic coil, and shows the location of the batch dispersion sample loading within coil, indicated as (0,0). FIG. 4C shows the picture of the sample placed within the coil for the heating study. The main apparatus is an induction heating unit made by Superior Induction, Pasadena, Calif. (SI-10KWHF model), which has a 10 kilowatt power supply, operates at up to 230 volts, and has an alternating frequency range of approximately 400-1000 kHz. The induction heater generates an alternating magnetic field by cycling an alternating current through a coil with a specific number of loops. Different frequencies require switching to different coils with a different number of turns. The current can be modulated from 3 to 44 Amps depending on the coil being used. The induction heater works in conjunction with a 15 gallon water cooling unit, which circulates chilling water through the coil to prevent overheating and equipment damage.

To monitor liquid temperature changes, a fluoroptic fiber optic temperature sensing unit called NOMAD® by Neoptix, Canada LP was used. The usage of a fiber optic temperature sensor prevents magnetic/electric field interference of measurements. When performing heating trials using dispersion samples, a plastic, insulated cuvette (4 mL max volume) was used as a sample holder. The fiber optic temperature sensor was placed approximately at the same position in the liquid within the sample holder to measure the local temperature. The heating induced by both types of particles, hydrophilic and hydrophobic, was characterized for frequencies of 390, 540, and 920 kHz at magnetic field strengths ranging from approximately 430-5000 A/m depending on the coil used. Samples were placed at the point (0,0) in FIG. 4A because the field is strongest at the center of the coil, radially, and at the midway point of the height of the coil. After placing the sample at the (0,0) position, it is exposed to the magnetic field for 10 to 30 seconds depending on the strength of the field. The field strength limits the time because samples in a larger magnetic field heat up faster. A dispersion of 10 wt % magnetite nanoparticles in water boils in approximately 10 seconds (100° C.), and a dispersion of 10 wt % particles in hexane boils in approximately 30 seconds (69° C.). In order to modulate the magnetic field strength, the current sent to the coil is varied. The current values used in this case were 5, 15, 25, 35, and 43 Amps. These values of current can be used to calculate the magnetic field strength depending on the number of coil turns and coil length using the following equation (simplified version):

$$\begin{matrix}B = \frac{( {μ}_{0} N * I )}{L} & ( 7 ) \\ H = μ B & ( 8 )\end{matrix}$$

where B is the magnetic flux density strength [T], N is the number of coil turns, I is the current [A], and L is the coil length [m], H is the applied magnetic field strength [A/m], and μ is the magnetic permeability of the solenoid coil core (air/magnetite nanoparticle dispersion core assumed ˜1 here). Power dissipation values did not follow a quadratic relationship with the magnetic field strength as expected from Equation (5). The first group of studies was conducted to characterize the heating behavior of the nanoparticles dispersed in batch liquid samples. The magnetic field was applied to each sample for a time up to 30 seconds, and the specific absorption rate (SAR, described in detail with Equations (9)) value was calculated for the amount of time that the field was applied. The samples were not allowed to thermally equilibrate since an adiabatic system was not used; thus the steady-state heating rate, rather than the transient heating rate was the experimental result of interest. The fluids and relevant fluid properties used for the batch dispersion experiments are shown in Table 1.

TABLE 1
Properties of Fluids Used for Batch
Dispersion Experiments.

| Fluid | ρ, kg/m³ | C_{ρ}, J/g K | k, W/m K |
|---|---|---|---|
| Water | 999 | 4.19 | 0.58 |
| Hexane | 655 | 2.26 | 0.12 |
| THF | 889 | 1.73 | 0.14 |

A summary of the batch dispersion studies performed on both hydrophobic and hydrophilic nanoparticles is included in Tables 2, 3, and 4. Table 2 contains SAR values obtained for hydrophilic EMG700 nanoparticles dispersed in water.

TABLE 2
Summary of SAR Values Obtained for 10 wt % EMG700
(Hydrophilic) Nanoparticles Dispersed in Water.

| H-field, A/m | 400 kHz, W/g | 540 kHz, W/g | 920 kHz, W/g |
|---|---|---|---|
| 556 | 16.4 | 10.8 | 4.84 |
| 1667 | 83.1 | 48.0 | 17.8 |
| 2778 | 148 | 94.1 | 33.9 |
| 3889 | 199 | 130 | 62.7 |

Table 3 contains SAR values obtained for hydrophobic EMG1400 nanoparticles dispersed in hexane.

TABLE 3
—Summary of SAR Values Obtained for 10 wt % EMG1400
(Hydrophobic) Nanoparticles Dispersed in Hexane.

| H-field, A/m | 400 kHz, W/g | 540 kHz, W/g | 920 kHz, W/g |
|---|---|---|---|
| 556 | 6.59 | 5.32 | 2.77 |
| 1667 | 12.1 | 12.9 | 9.14 |
| 2778 | 17.0 | 23.0 | 19.1 |
| 3889 | 24.8 | 33.5 | 28.8 |

Table 4 contains experimental SAR values obtained for EMG1400 nanoparticles dispersed in THF.

TABLE 4
Summary of SAR Values Obtained for 10 wt % EMG1400
(Hydrophobic) Nanoparticles Dispersed in THF.

| H-field, A/m | 400 kHz, W/g | 540 kHz, W/g | 920 kHz, W/g |
|---|---|---|---|
| 556 | 4.16 | 3.34 | 2.54 |
| 1667 | 12.2 | 9.43 | 8.71 |
| 2778 | 21.5 | 20.7 | 16.8 |
| 3889 | 27.5 | 28.2 | 22.5 |

The capability of paramagnetite nanoparticles for heating was conducted with hydrophilic and hydrophobic nanoparticles dispersed in different fluids for a range of conditions. Results show how the specific absorption rate (SAR) of a sample changes with magnetic field strength and frequency. SAR whose units are W/g_{Fe}_{₃}_{O}_{₄}, or the thermal energy absorbed by the dispersing fluid per unit time per gram of iron oxide in the dispersion, is given in a simplified form:

$${SAR}_{static} = \frac{{c}_{p} Δ T}{Δ {tw}_{{Fe}_{3} {O}_{4}}} \qquad ( 9 )$$

where cₚ is the specific heat capacity of the solvent [J/g ° C.], ΔT is the change in temperature [° C.], Δt is the time elapsed during the experiment [s], and w_{Fe}_{₃}_{O}_{₄} is the weight fraction of magnetite in the dispersion.

FIG. 5 shows the measured SAR values with magnetic field strength squared for 10.5 wt % hydrophobic magnetite NPs dispersed in hexane. A sample size of 1 mL was used. A nanoparticle core diameter was measured to be 12.1±3.0 nm. The quadratic H-field values corresponds to relatively small H-field values; comparable magnetic flux density values (B-field) for the x-axis are 0.4 to 6.3 militeslas.

Next heating characterization was performed for the hydrophilic magnetite nanoparticles dispersed in water. The EMG700 was diluted down to 10 wt % dispersion (originally 29 wt %). These were performed in exactly the same manner as the hydrophobic nanoparticle studies, e.g., applying magnetic fields from 400-5000 A/m at frequencies of 390, 540, and 920 kHz for 1 mL samples placed at position (0,0).

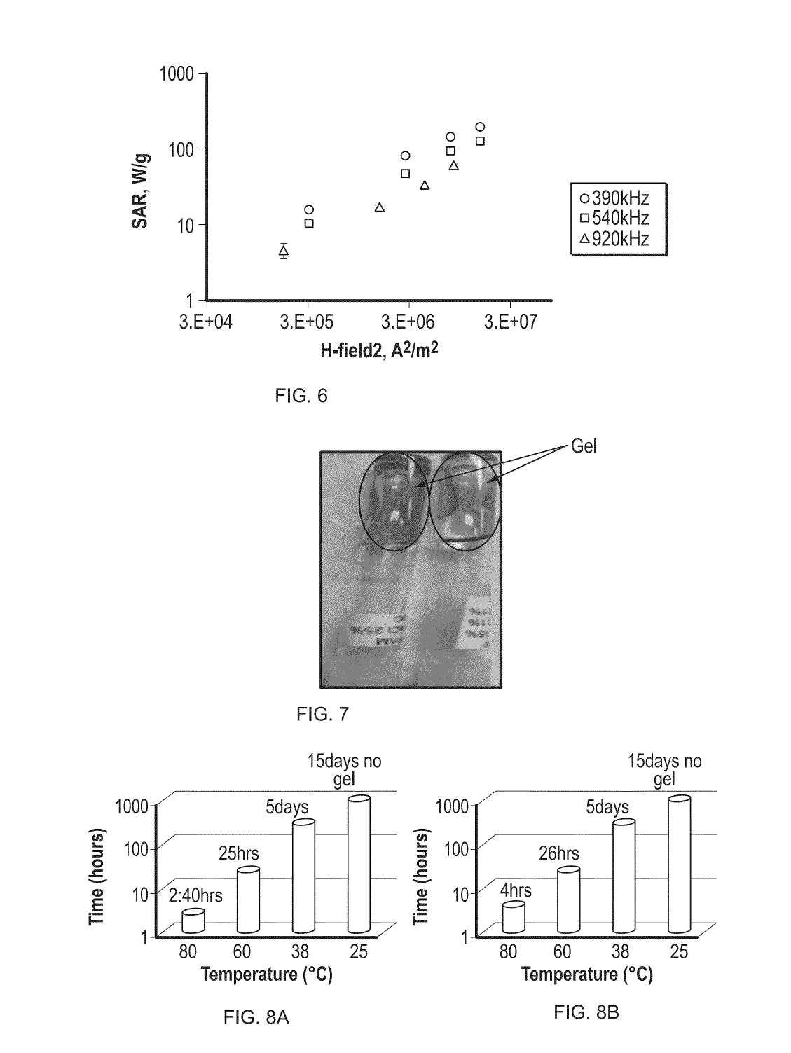

FIG. 6 shows the heating results for the hydrophilic nanoparticles. The measured SAR values for 10 wt % hydrophilic magnetite nanoparticles in water at varying magnetic fields and frequencies.

Dependence of Gel Formation on Temperature. In the above section, the ability of the paramagnetic nanoparticles to quickly heat the dispersing liquid was demonstrated. The temperature increase can be utilized to trigger the formation of gel from a mixture of polymer, crosslinker and magnetic nanoparticles. To form a gel, polyacrylamide or polysaccharide can be linked with metallic or organic cross-linkers, such as aluminum or chromium acetate. Partially hydrolyzed polyacrylamide (HPAM), HPAM modified with 2-acrylamido 2-methyl propane sulfonate (AMPS) and n-vinyl pyrrolidone (NVP) side groups along its molecular chain (with trade name, SAV505), and xanthan biopolymer were used as polymer, and chromium acetate and PEI as a cross-linker. These compounds were mixed in different concentrations, different ratio, and in different concentration and types of salt to form several gallant systems. When polymer and cross-linker are mixed, the cross-linkers attach to certain sites along polymer chains, and form the polymer networks. If the bond forces are strong, the gel solution will become extremely rigid. Organically cross-linked gels are known to have good stability at elevated temperatures. A copolymer of acrylamide and tert-butyl acrylate (PAtBA) cross-linked with polyethyleneimine (PEI) was reported (Jia et al. 2010) which was quite stable at high temperatures.

HPAM FP3330, SAV505, and xanthan biopolymer were obtained from SNF Floerger (Cedex, France). Iron oxide nanoparticles (EMG700) were obtained from FeroTec, Germany. Chromium acetate, Polyethyleneimine (PEI), sodium chloride (NaCl), calcium chloride (CaCl₂), and magnesium chloride (MgCl₂) were obtained from Fisher Scientific.

Generating a SAV505 polymer-chromium acetate gel from the reaction of a polymer with a crosslinker, the reaction time depends on the concentration of polymer, concentration of crosslinker, pH of the reaction mixture and, in particular, temperature. The SAV505 polymer-chromium acetate gel was synthesized by the reaction of SAV505 with chromium acetate at different temperatures. Polymer and chromium acetate were mixed so that final solution has 8000 ppm polymer, 1900 ppm chromium acetate and 5 wt % salt (either NaCl or a mixture of NaCl, CaCl₂ and MgCl₂) in water. The solution was kept in oven at different temperatures, and the time taken to form gel was measured.

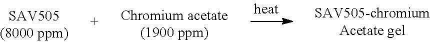

The procedure for the synthesis of HPAM FP3330-chromium acetate gel is very similar to that for SAV505 polymer-chromium acetate gel formation. 5000 ppm HPAM polymer solution was prepared as a stock solution, and 9600 ppm chromium acetate in 25 wt % NaCl brine was prepared as a stock solutions. The two stock solutions were mixed such that final solution has 2000 ppm polymer, 1900 ppm chromium acetate and 5 wt % NaCl in water, which was kept in oven at different temperatures, and the time taken to form gel was measured.

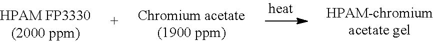

The procedure for the synthesis of xanthan-chromium acetate gel is same as for the SAV505-chromium acetate gel formation. 3000 ppm xanthan solution was prepared as a stock solution and 9600 ppm chromium acetate in 25 wt % NaCl brine was prepared as a stock solutions. The stock solutions were mixed to produce a solution which has 8000 ppm polymer, 1900 ppm chromium acetate and 5 wt % NaCl in water. It was kept in oven at different temperatures, and the time taken to form gel was measured.

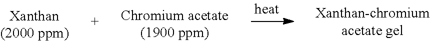

The procedure for the synthesis of HPAM-PEI gel is same as that for SAV505-chromium acetate gel formation. 5000 ppm HPAM solution and another solution with 1% PEI in 5 wt % NaCl brine were prepared, which were mixed to obtain the final solution that has 2000 ppm polymer, 0.6 wt % PEI and 3 wt % NaCl in water. This was kept in oven at different temperatures, and the time taken to form gel was measured. This mixture is basic (pH-10), so NaOH was not used.

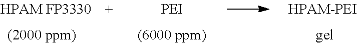

As the mixture of 8000 ppm SAV505 and 1900 ppm chromium acetate was acidic with pH-3.2, drops of NaOH solution were added to obtain pH=7.7. The solution in different small glass vials was kept at different temperatures and the time to form gel was measured, which is given in Table 5. It is noted that at room temperature gel was not formed for up to 15 days. Table 5 shows that as the temperature increases, the gelling time gradually decreases. For the solution that has divalent ions, gelling was somewhat delayed compared to the corresponding solutions having no divalent ions.

TABLE 5
Gel formation of SAV505-chromium acetate mixture.

| | | | | | 8000 ppm SAV 505 + 3% NaCl + 1% | | | |
|---|---|---|---|---|---|---|---|---|
| | 8000 ppm SAV505 + 5% NaCl + 1900 | | | | CaCl₂ + 1% MgCl₂ + 1900 ppm | | | |
| Temp | ppm Chromium acetate (pH 7.7) | | | | Chromium acetate (pH 7.7) | | | |
| Time | 25° C. | 38° C. | 60° C. | 80° C. | 25° C. | 38° C. | 60° C. | 80° C. |
| 2:00 hrs | No | No | No | No | No | No | No | No |
| 2:40 hrs | No | No | No | Starts | No | No | No | No |
| 4:00 hrs | No | No | No | Viscous | No | No | No | Starts |
| 5:40 hrs | No | No | No | Very thick | No | No | No | Very |
| | | | | | | | | thick |
| 24 hrs | No | No | Starts | Very thick | No | No | No | Very |
| | | | | | | | | thick |
| 25 hrs | No | No | thicker | Very thick | No | No | Starts | Very |
| | | | | | | | | thick |
| 5 days | No | Slightly | Viscous | Very thick | No | Slightly | Viscous | Very |
| | | | | | | | | thick |
| 15 days | No | Slightly | Viscous | Very thic | kNo | Slightly | Viscous | Very |
| | | | | | | | | thick |

FIG. 7 shows the gels formed from the SAV505 solutions with (right) and without (left) divalent ions, after 15 days. Both gels were very viscous and remained without falling down in the tube, when they were inverted. FIGS. 8A & 8B show the gelling time versus temperature for SAV505; FIG. 8A with NaCl, and FIG. 8B with NaCl and divalent ions, as seen in FIG. 7.

Table 6 lists the gelation time of SAV505 at different pH at 80° C. in 5 wt % NaCl brine. The pH range from 5 to 8 appears to be favorable for gel formation. At higher pH (=11), polymer precipitation occurred; and for pH=3, it took at least a week to form gel.

TABLE 6
Gelation study of SAV505 with change of pH.
8000 ppm SAV505 + 5% NaCl + 1900 ppm Chromium acetate at 80° C.

| pH | | | | | | |
|---|---|---|---|---|---|---|
| Time | | 4.1 | 5.3 | 6.0 | 7.7 | 11 |
| 2:45 | hrs | No | No | Starts | Starts | No |
| 3:00 | hrs | No | Starts | More thicker | More | No |
| | | | | | thicker | |
| 7:00 | hrs | No | More | More thicker | Very thick | No |
| | | | thicker | | | |
| 22 | hrs | Starts | Very thick | Very thick | Very thick | No |
| 26 | hrs | Very thick | Very thick | Very thick | Very thick | No |
| 28 | hrs | Very thick | Very thick | Very thick | Very thick | No |

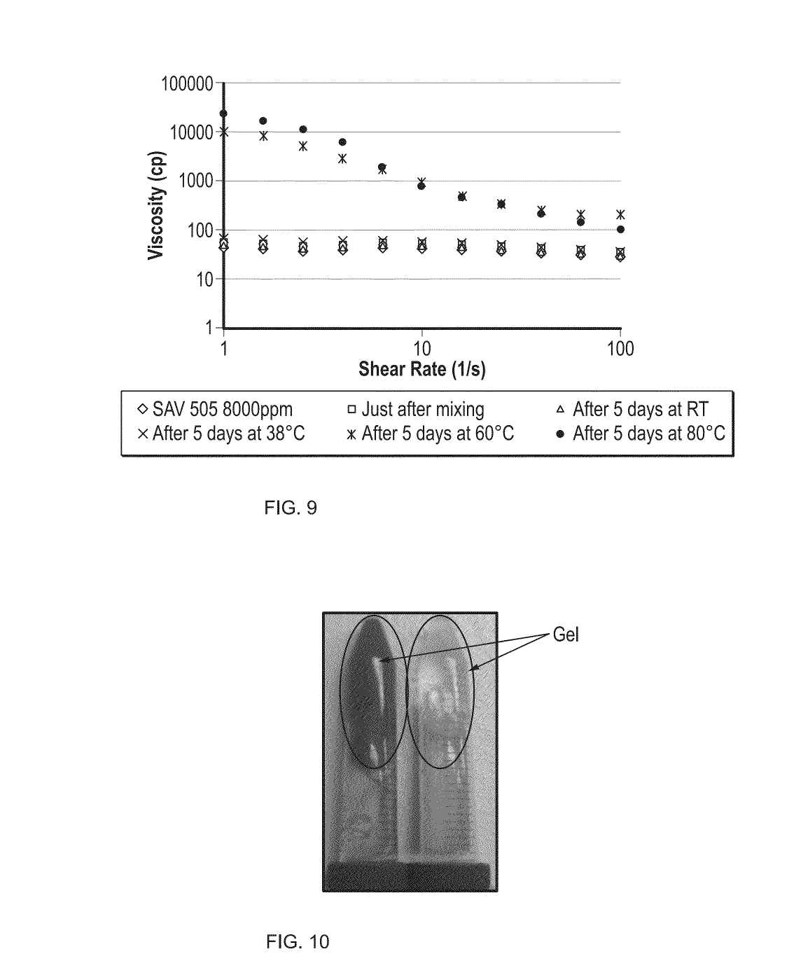

FIG. 9 shows the viscosities of the mixture of 8000 ppm SAV505 and 1900 ppm chromium acetate in 5 wt % NaCl at different temperatures. The viscosities were measured right after the mixture generation, and after 5 days at different temperatures. The gel formed at 80° C. and 60° C. are very viscous in comparison to the gel formed at lower temperatures.

The gel formation was studied for the xanthan and HPAM with chromium acetate. For both of them, gel was formed without iron oxide nanoparticles but with iron oxide nanoparticles gel could not be formed. Without the nanoparticles, however, the gel formation time was quite similar to the SAV505 system and followed similar trends with increasing temperature, changing pH, and changing salt type.

The SAV505-chromium acetate gel formation method was applied in the above mentioned mixtures by mixing some iron oxide nanoparticles but gel was not formed. Because of the chromium acetate, iron of the iron oxide nanoparticles reacts with acetate to form iron acetate so the cross-link could not be formed between them. After the failure of this process the two options were to coat the iron oxide nanoparticles with some polymer as follow the above mentioned procedure by adding some coated iron oxide nanoparticles or to find something else gelling agent instead of chromium acetate.

A HPAM FP3330-PEI gel was successfully formed from the HPAM-PEI system, both without and with iron oxide nanoparticles added, above a certain temperature. Table 10 shows the gel formation time for 2000 ppm FP3330 with different PEI concentrations, at 80° C., with and without Fe₃O₄ nanoparticles, and also with and without NaCl salt in water. The preliminary result shows that gel can be formed very quickly with and without Fe₃O₄ nanoparticles for the composition with no salt.

FIG. 10 shows the formation of gel for 2000 ppm of HPAM and 5 wt % PEI, left with Fe₃O₄ nanoparticles and right has no nanoparticles. In the inverted vials, the gels formed remain firm without flowing down, for both systems with and without Fe₃O₄ nanoparticles. For the systems with 3 wt % NaCl, the gel formation was not observed for many days for both systems with and without Fe₃O₄ nanoparticles. The gel formation at different salt concentration, polymer concentration, and PEI concentration at 90° C., was investigated, and the results are given in Table 7. For the solution which contains 5% PEI, gel started in 35 minutes but the gel formed was very strong but for the solution with 0.6% or 1.2% PEI, the gel started to form after about 45 minutes but the gel was very weak.

TABLE 7
Gelation study with and without salt and Fe₃O₄ nanoparticles.

| Composition | Gel started at 90° C. |
|---|---|
| 2000 ppm HPAM + 1.2% PEI (pH~10) | 45 minutes |
| 2000 ppm HPAM + 1.2% PEI + 3% NaCl (pH~10) | Did not form up |
| | to 6 days |
| 2000 ppm HPAM + 0.6% PEI (pH~10) | 45 minutes |
| 2000 ppm HPAM + 1.2% PEI + Fe₃O₄-NP (pH~10) | 80 minutes |
| 2000 ppm HPAM + 1.2% PEI + 3% NaCl + | Not formed for |
| Fe₃O₄-NP (pH~10) | many days |
| 2000 ppm HPAM + 2% PEI + 3% NaCl | Not formed for |
| | many days |
| 2000 ppm HPAM + 3% PEI + 3% NaCl | Not formed for |
| | many days |
| 2000 ppm HPAM + 4% PEI + 3% NaCl | Not formed for |
| | many days |
| 2000 ppm HPAM + 5% PEI + 3% NaCl | Not formed for |
| | many days |
| 2000 ppm HPAM + 5% PEI | Gel formed in 35 mins. |
| 2000 ppm HPAM + 5% PEI + Fe₃O₄-NP | Gel formed after 1 hr. |

The gel formation reaction for the HPAM-PEI system, without and with nanoparticles, having different polymer concentration, different PEI concentration and different salt concentration. The results are shown in Table 8.

TABLE 8
Gelation study with and without salt and Fe₃O₄ nanoparticles at 90° C.

| | |
|---|---|
| | Gel started time at |
| Composition | 90° C. |

Effect of PEI Concentration [HPAM (2500 ppm), NaCl (3%)]

| | |
|---|---|
| 2500 ppm HPAM + 2% PEI + 3% NaCl | Not formed for |
| | many days |
| 2500 ppm HPAM + 3% PEI + 3% NaCl | Not formed for |
| | many days |
| 2500 ppm HPAM + 4% PEI + 3% NaCl | Not formed for |
| | many days |

Effect of Varying NaCl [HPAM (2500 ppm), PEI (4%)]

| | |
|---|---|
| 2500 ppm HPAM + 4% PEI + 1% NaCl | Started in 7.5 hrs |
| 2500 ppm HPAM + 4% PEI + 0.5% NaCl | Started in 2.5 hrs |

Effect of Varying NaCl [HPAM (2000 ppm), PEI (5%)]

| | |
|---|---|
| 2000 ppm HPAM + 5% PEI + 1% NaCl | Started in 9 hrs, |
| | but not highly |
| | viscous |
| 2000 ppm HPAM + 5% PEI + 0.5% NaCl | Started in 3.5 hrs |

Effect of Nanoparticle Addition on Gel Formation

| | |
|---|---|
| 2500 ppm HPAM + 4% PEI + 0.5% NaCl + Fe₃O₄-NP | Started in 5 hrs |
| 2000 ppm HPAM + 5% PEI + 0.5% NaCl + Fe₃O₄-NP | Started in 6 hrs |

From Table 8, systems with 3 wt % NaCl, gel was not formed even when the polymer concentration was increased from 2000 ppm to 2500 ppm and PEI concentration from 2 to 4 wt %. To study the effect of salt on gel formation, the salt concentration was decreased from 3 wt % to 1 wt % and 0.5 wt %. For these systems, gel was formed in a reasonable time at 90° C. Table 8 also shows the gel formation for the same systems with addition of Fe₃O₄ nanoparticles. 0.2 ml Fe₃O₄ nanoparticles in 5 ml of total solution was added and the gel formation time measured. For both 0.5% and 1% NaCl solutions, gel was formed with and without Fe₃O₄ nanoparticles. The effect of salt on gel formation was further studied with the HPAM concentration of 3000 ppm at 90° C. and 60° C. The results are given in Table 9. Gel was formed for 1% NaCl within a day but for 3% NaCl, gel was not formed for many days. Also, for the system with 1% NaCl, gel obtained at 60° C., even though it took a long time and the gel formed was not very viscous.

TABLE 9
Gelation study with high concentration of salt and Fe₃O₄ nanoparticles.

| | |
|---|---|
| Composition | Gel Start Time |

Gel formation with nanoparticles in presence of 1% NaCl at 90° C.

| | |
|---|---|
| 3000 ppm HPAM + 4% PEI + 1% NaCl | After 12 hrs. |
| 3000 ppm HPAM + 4% PEI + 1% NaCl + Fe₃O₄-NP | After 12 hrs. |

Gel formation with nanoparticles in presence of 1% NaCl at 60° C.

| | |
|---|---|
| 3000 ppm HPAM + 4% PEI + 1% NaCl | Formed after 24 hrs. |
| 3000 ppm HPAM + 4% PEI + 1% NaCl + Fe₃O₄-NP | Formed after 24 hrs. |
| | Weak gel still after |
| | 4 days |

Gel formation with nanoparticles in presence of 3% NaCl at 90° C.

| | |
|---|---|
| 3000 ppm HPAM + 4% PEI + 3% NaCl | Not formed for |
| | many days |
| 3000 ppm HPAM + 4% PEI + 3% NaCl + Fe₃O₄-NP | Not formed for |
| | many days |

Generation of a polymer gel without using a crosslinker chemical. A novel method of generating a polymer gel at a specified location in a subsurface formation is described hereinabove by adding superparamagnetic nanoparticles to the gel-forming polymer and crosslinker chemical, and heating the polymer-crosslinker mixture by the nanoparticle-based hyperthermia. Following the teachings hereinabove, the inventors show additional examples of gel-forming polymers. Specifically, for these new formulations, the polymer dispersions do not require the crosslinker chemical, because they auto-crosslink upon raising temperature.

The temperature-triggered self-polymerization can be achieved with various polysaccharides such as methyl cellulose (MC), hydroxypropyl methylcellulose (HPMC), and curdlan, and can be employed for the present invention, instead of the above-described use of a polymer and a crosslinker chemical. For HPMC and MC, the gel formation efficiency was enhanced by the presence of salts. Curdlan, though insoluble in water, forms nice gel in the presence of salt and iron oxide nanoparticles at high temperature, as described in more detail below.

The molecular formula of methyl cellulose is C₆H₇O₂(OH)ₓ(OCH3)_{y} where the x and y stands for number of units and the molecular formula of hydroxypropyl methylcellulose is C₆H₇O₂(OR1)(OR2)(OR3) where R1, R2 and R3 may be different groups such as —H, —CH₃, —CH₂CHOHCH₃. The structures of the polymers are given below.

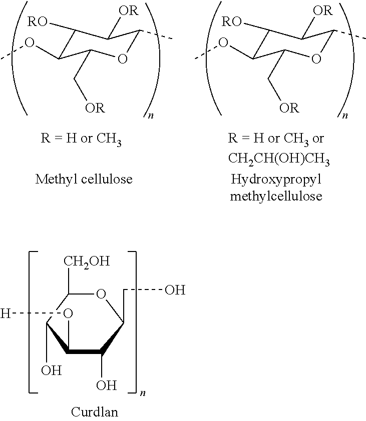

As for the iron oxide nanoparticles employed for heating, we used not only EMG 700 and EMG 605, as were used for the above tests, but also the 100K, 450K, and APTES iron oxide nanoparticles, which were synthesized in-house. 100K and 450K are the polyacrylic acid (100 kDa and 450 kDA)-coated nanoparticles and APTES is 3-amino propyltriethoxysilane-coated superparamagnetic nanoparticles.

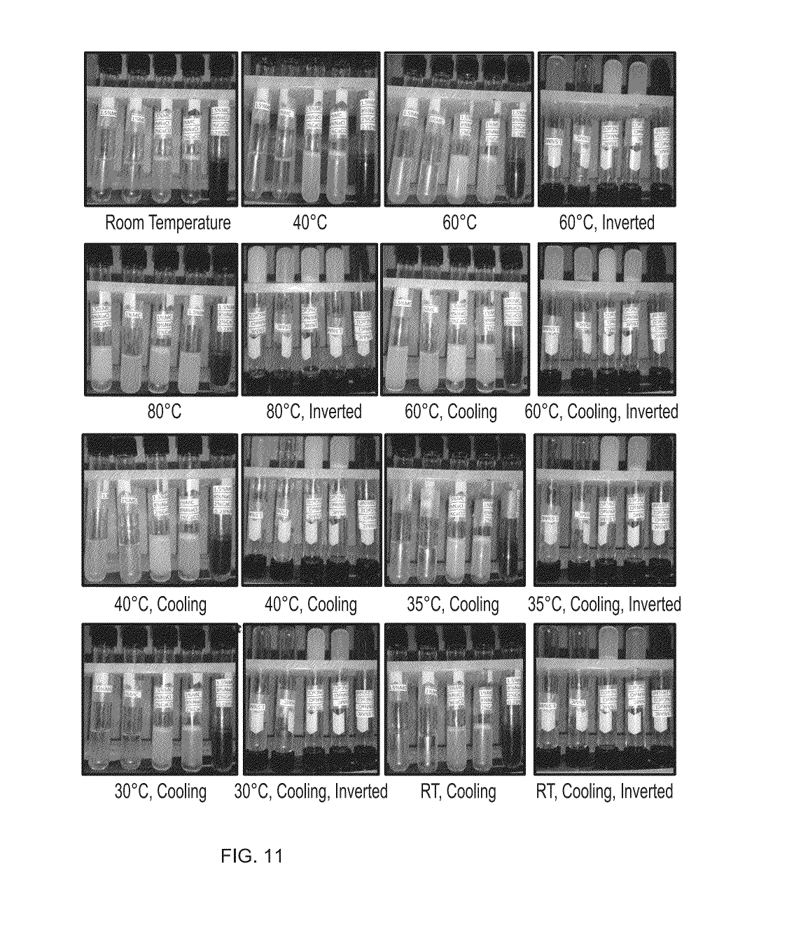

Formation of methylcellulose (MC) gel. Different amount of MC was mixed with different amount of salts and stirred until they get dissolved. The solutions were then heated and kept at different temperature for about half an hour; then cooled from 80° C. to room temperature and the observed results are tabulated in the Table 10 and also shown in FIG. 11. For the cases indicated as “gel”, the gel forms within 10 minutes. At room temperature (RT), gel was not formed for many days, but at a certain higher temperature the gel generally formed very quickly. Gel starts to form at about 40° C. for the solution with salt but the strength of gel seems to be increasing with increasing temperature from 40 to 80° C. For the solution without salt, the gel started to form at about 70° C. but for the solution with salt, gel started to form at about 35-40° C. As the gelling process is reversible, the inventors studied how the gel changes to solution by decreasing the temperature from 80° C. to room temperature. The effect of iron oxide nanoparticles on the gelling process was also studied and it was found that there is no adverse effect of adding iron oxide nanoparticles (Fe₃O₄) in the solution and the results are shown as the last column in Table 10. For the solution with no salt, gel changed to solution at about 50° C., but for the solutions with salt, gel did not dissolve even at room temperature for few hours.

TABLE 10
Gel formation of MC at different temperature (Temperature
first raised to 80° C. then cooled to room temperature).

| | | | | | 1.5 wt % |
|---|---|---|---|---|---|
| | | | 1.5 wt % | 1 wt % | MC + 8% |
| | 1.5 wt % | 1 wt % | MC + 8% | MC + 8% | NaCl + 2% |
| Temp | MC | MC | NaCl + 2% | NaCl + 2% | CaCl₂ + 0.28% |
| (° C.) | (no salt) | (no salt) | CaCl₂ | CaCl₂ | NP |
| RT | solution | solution | solution | solution | solution |
| 40 | no gel | no gel | gel | gel | gel |
| 50 | no gel | no gel | gel | gel | gel |
| 60 | gel | no gel | gel | gel | gel |
| 80 | gel | gel (weak) | gel | gel | gel |
| 50 | no gel | no gel | gel | gel | gel |
| 40 | no gel | no gel | gel | gel | gel |
| 30 | no gel | no gel | gel | gel | gel |
| RT | no gel | no gel | gel for hours | gel for hours | gel for hours |

FIG. 11 shows the formation of MC gel. From left to right in each photo: From left to right: (tube 1) 1.5% MC; (tube 2) 1% MC; (tube 3) 1.5% MC+8% NaCl+2% CaCl₂; (tube 4) 1% MC+8% NaCl+2% CaCl₂ and (tube 5) 1.5% MC+8% NaCl+2% CaCl2+0.28 wt % Fe₃O₄—NP. From the pictures in FIG. 11, it is clear that gel starts to form at about 40° C. for the samples with salts and the gel does not move even if the tubes were inverted. The inventors slowly cooled the solution after heating at 80° C. to see whether the gel-sol transition occurs at the same temperature as the sol-gel transition occurs. When the samples were started to cool down, at 40° C., only the solution of 1 wt % MC was moving because the gel was weak but the 1 wt % MC solution in presence of salts is still strong and did not change to solution even at room temperature for about an hour.

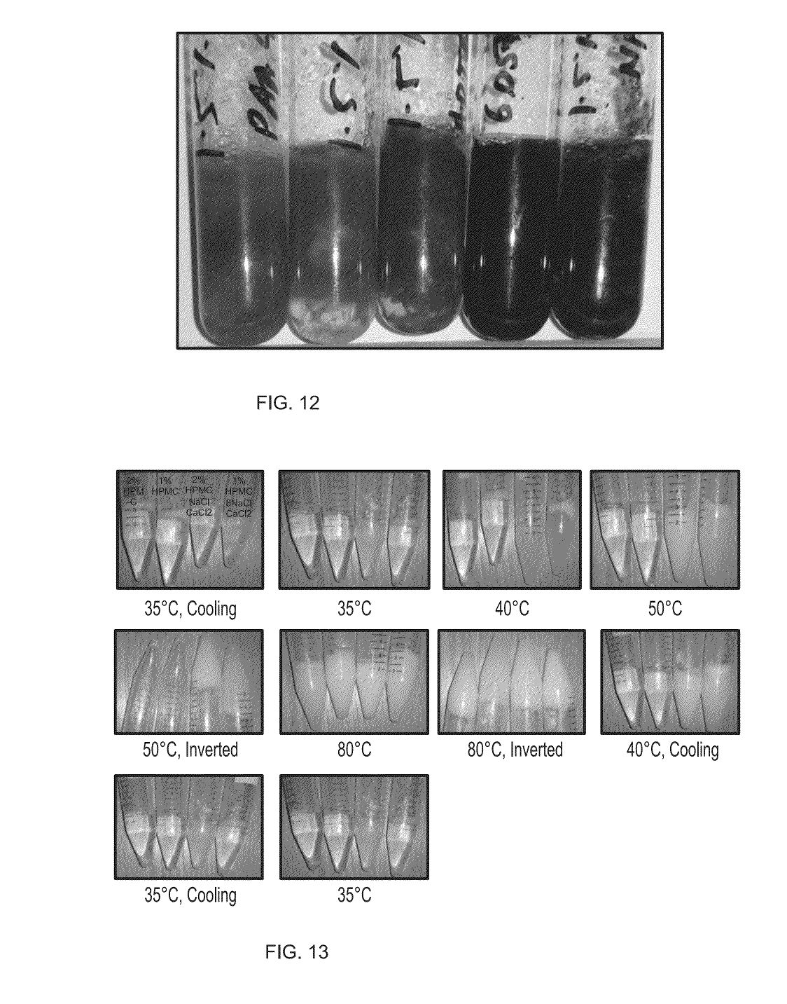

The effect of different types of iron oxide nanoparticles in the MC solution was studied. It was found that the gel formation process is not affected by the addition of iron oxide nanoparticles, as shown in FIG. 12. Equal amount of different types of iron oxide nanoparticles were added such as EMG 700, EMG 605, and the in-house synthesized nanoparticles coated with different polymer ligands such as PAA100K, PAA450K. The different kinds of coating did not show any adverse or improved effect on gel formation. FIG. 12 shows the formation of MC gel with different nanoparticles with different surface coating. (From left to right: In-house synthesized nanoparticles with coating of PAA100K, PAA450K and APTES; and EMG 700 and EMG 605).

Formation of hydroxypropyl Methylcellulose (HPMC) gel. The test samples were prepared in the similar way as that for methyl cellulose above. Different amount of HPMC was mixed with different amount of salts and stirred until they are dissolved. The solutions were then heated by keeping at different temperatures for about half an hour; and then cooled to room temperature again by keeping at different temperature and the observed results are tabulated in Table 11 and FIG. 13. FIG. 13 shows the formation of HPMC gel. From left to right in each photo: (tube 1) 2% HPMC; (tube 2) 1% HPMC; (tube 3) 2% HPMC+8% NaCl+2% CaCl₂; and (tube 4) 1% HPMC+8% NaCl+2% CaCl₂. It was observed that at room temperature, gel was not formed even after several days; but at certain higher temperatures, the gel forms very quickly. For all cases gel starts to form at about 40° C. but the strength of gel seems to be increasing with increasing temperature from 40° C. to 80° C. The gel is stable at least up to 125° C. As the gelling process is reversible, how the gel changes to solution by decreasing the temperature from 80° C. to room temperature was studied. It was observed that the samples with salt remain as gel at temperatures as low as 30° C.; but at room temperature, the gel changed to solution after about half an hour.

TABLE 11
Formation of HPMC gel. (Temperature first raised to 125° C. then
cooled to room temperature).

| | 2 wt % | | | |
|---|---|---|---|---|
| Temp | HPMC | 1% HPMC | 2% HPMC + 8% | 1% HPMC + 8% |
| (° C.) | (no salt) | (no salt) | NaCl + 2% CaCl₂ | NaCl + 2% CaCl₂ |
| RT | viscous | Non viscous | viscous | Non viscous |
| | transparent | transparent | transparent | transparent |
| 30 | viscous | transparent | transparent | transparent |
| | transparent | | | |
| 35 | viscous | transparent | white | transparent |
| | transparent | | | |
| 40 | solution | solution | white gel (weak) | white gel (weak) |
| | | | does not move | does not move |
| | | | | when inverted |
| 50 | solution | solution | white gel (weak) | white gel (weak) |
| | | | does not move | does not move |
| | | | | when inverted |
| 60 | solution | solution | white gel | white gel |
| 70 | white gel | white gel | white gel | white gel |
| 80 | white gel | white gel | white gel | white gel |
| 125 | white gel | white gel | white gel | white gel |
| 70 | white gel | white gel | white gel | white gel |
| 60 | white gel | white gel | white gel (strong) | white gel (strong) |
| | (moving) | (moving) | | |
| 50 | Solution, | Solution, | white gel (strong) | white gel (strong) |
| | white | white | | |
| 40 | solution, | solution, | white gel (strong) | white gel (strong) |
| | transparent | transparent | | |
| 35 | solution, | solution, | white gel (strong) | white gel (strong) |
| | transparent | transparent | | |
| 30 | solution, | solution, | white gel (strong) | white gel (strong) |
| | transparent | transparent | | |
| RT | solution, | solution, | solution, | solution, |
| | transparent | transparent | transparent | transparent |

When these solutions are heated, at 35° C., only 2% HPMC in the 8wt % NaCl became slightly whitish and the rest of the solutions were still water-like. At 40° C., the solutions containing salts formed gels but the solutions without salt were not even started to gel. When the temperature was gradually increased, at 70° C., the solutions without salt also formed gel, and all the gels looked equally strong. All four formulations were further heated to 125° C., and gradually cooled to them. At 60° C., the gels without salt were moving though still a weak gel. The rest of the samples remained as strong gels. At 50° C., the formulations without salt were no longer gel; but white colloidal dispersions. At the temperature of 40° C. or lower, the formulations are reverted to transparent solutions. On the other hand, the formulations with salts remained as gel at temperatures down to 30° C.; but at room temperature, even these formulations became transparent solutions after about half an hour. From FIG. 13, how the gel forms at different temperatures, and starts to dissolve when cools down, can be observed.

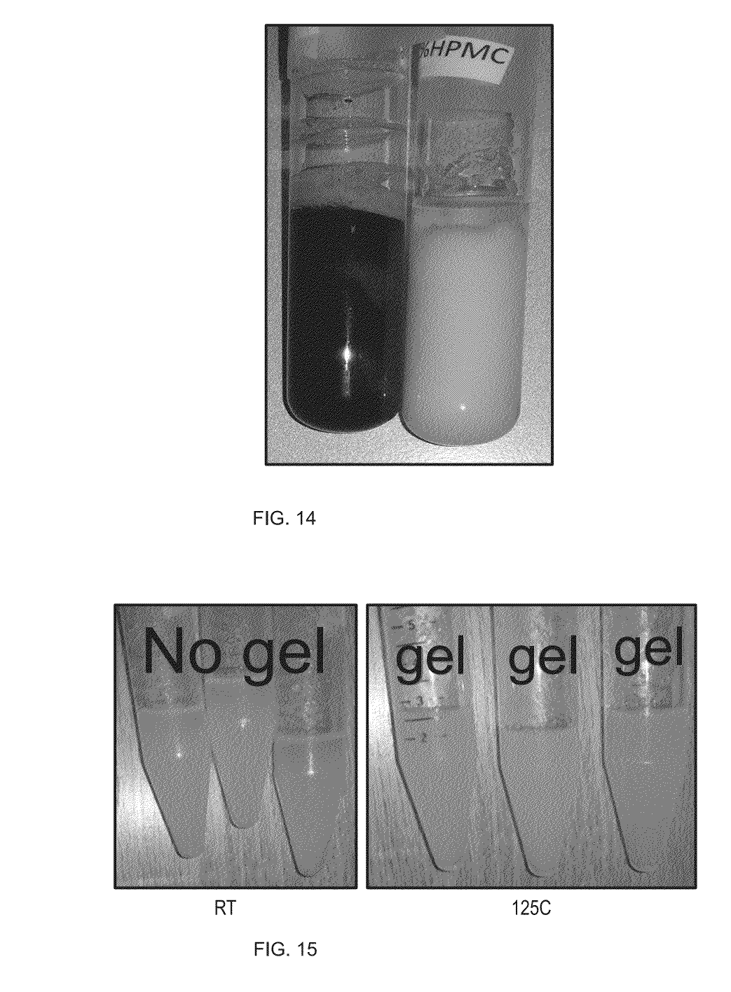

Furthermore, the 1 wt % HPMC solution containing 0.28 wt % iron oxide nanoparticles with salt (8 % NaCl+2% CaCl₂) was heated and the results are shown in Table 12 and FIG. 14. FIG. 14 shows the formation of HPMC gel (left: 1% HPMC+8% NaCl+2% CaCl₂+0.28% Fe₃O₄; and right: 1% HPMC+8% NaCl+2% CaCl₂). It was found that there is no adverse effect of adding iron oxide nanoparticles in the solution: gel started to form at about 70° C. for the solution with no salts, but for the solution with salt the gel formed at about 40° C. The effect is also same when cooling the gel: for the sample without salt, the gel reverted to solution at about 50° C., but for the sample with salt, it remained as at temperatures gel as low as 30° C.

TABLE 12
Gel formation of HPMC in presence of iron oxide nanoparticles.

| Temp | 1 wt % HPMC | 1 wt % HPMC + 8% NaCl + |
|---|---|---|
| (° C.) | (no salt) | 2% CaCl₂ + 0.28% NP |
| RT | solution | suspension |
| 40 | solution | gel |
| 70 | gel | gel |
| 80 | gel | gel |

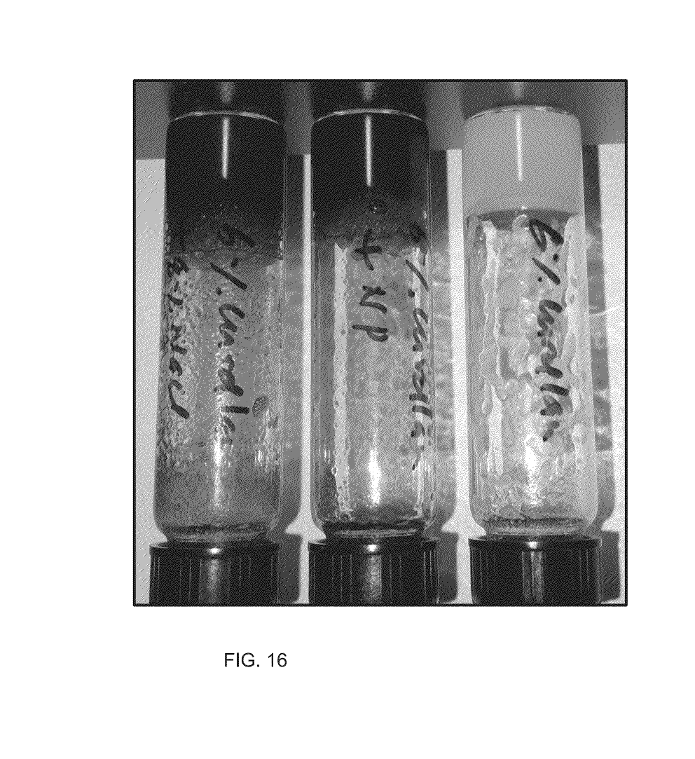

Formation of curdlan gel. Curdlan is insoluble in water but it forms a nice colloidal dispersion in water. When the suspension of curdlan is heated at high temperature (>80° C.), a nice gel can be formed. The curdlan is a homogeneous dispersion even in a high-salt brine but low concentration of curdlan does not form gel, and it needs to be about 4 wt % or higher to form a nice gel. 6 wt % curdlan was heated with and without 0.28 wt % iron oxide nanoparticles and heated at 125° C. for about 10 minutes, which produced a very nice gel, as shown in FIGS. 15 and 16. To test the compatibility with salt, 6 wt % curdlan was prepared by mixing 8% NaCl and 2% CaCl₂, and kept at different temperatures from 40° C. to 125° C. to observe the gel formation. The result is given in Table 13 and FIG. 15. FIG. 15 shows the formation of curdlan gel. In each picture, from left to right: (a) 6% curdlan; (b) 6% curdlan+8% NaCl+2% CaCl_{2;} and (c) 6% curdlan+2% NaCl). FIG. 15 shows that at room temperature there is no gel formation by any solution, even though the solutions looked cloudy. But at 125° C., all solutions formed very nice gels.

TABLE 13
Gelation study of curdlan at different temperature.

| Temp | | 6 wt % curdlan + 8 wt % | 6 wt % curdlan + |
|---|---|---|---|
| (° C.) | 6 wt % curdlan | NaCl + 2 wt % CaCl₂ | 2 wt % NaCl |
| RT | suspension | suspension | suspension |
| | (not viscous) | (not viscous) | (not viscous) |
| 40 | suspension | suspension | suspension |
| | (not viscous) | (not viscous) | (not viscous) |
| 50 | suspension | suspension | suspension |
| | (not viscous) | (not viscous) | (not viscous) |
| 60 | suspension | suspension | suspension |
| | (not viscous) | (not viscous) | (not viscous) |
| 70 | very thick solution | very thick solution | very thick solution |
| 80 | very thick solution | almost gel | very thick solution |
| 90 | gel | gel | gel |
| 100 | gel | gel | gel |
| 110 | gel | gel | gel |
| 125 | gel | gel | gel |

The effect of iron oxide nanoparticles on the curdlan gel formation was also studied. We found that the curdlan forms very nice and strong gel in presence of iron oxide nanoparticles; but very high amount of salt has adverse effect on the gel formation. Curdlan can form gel in presence of the 10% salt without nanoparticles; but in presence of nanoparticles, only the salt concentration of about 3 wt % (2 wt % NaCl, 1 wt % CaCl₂) or lower effectively forms gel. Higher concentrations of salts retard the gel formation, and the result is shown in the Table 14 and in FIG. 16. FIG. 16 shows the formation of curdlan gel demonstrated with the tubes that are inverted. From left to right: (left) 6% curdlan+1% NaCl+1% CaCl₂+0.28% Fe₃O₄ NP; (center) 6% curdlan+0.28% Fe₃O₄ NP; and (right) 6% curdlan).

The inventors also tested the gel formation of 6 wt % curdlan in the presence of iron oxide nanoparticles for sea brine and obtained gel. The sea water thus does not have any negative effect in sea brine to form gel.

TABLE 14
Gelation study of curdlan in presence of iron oxide nanoparticles.

| | | | 6 wt % curdlan + 1% |
|---|---|---|---|
| Temp | | 6 wt % curdlan + | NaCl + 1% CaCl₂ + |
| (° C.) | 6 wt % curdlan | 0.28%NP | 0.28% NP |
| RT | suspension | suspension | suspension |
| 80 | gel | gel | no gel |
| 125 | gel | gel | gel |

At 80° C., only the first formulation (Table 14) appeared to form a gel, but all three formulations formed very weak gel when cooled for about half an hour. Above 80° C., all solutions formed gel. These gels are irreversible with temperature and seem much less enhanced by the addition of salt. In other words, salts have almost no effect on the formation of gel, unlike the HPMC and MC formulations.

It was found that: (1) Self gelation of different biopolymers (polysaccharides) at raised temperatures was studied as a function of temperature and salt concentration; (2) Gel formed for all biopolymers studied. They are compatible with iron oxide nanoparticles and form nice strong gels; (3) In all cases the gel formation with MC, HPMC, and curdlan was enhanced by the presence of salt. For MC and HPMC, gel becomes stronger with the increasing concentration of salt; but for curdlan, salt only slightly enhances the formation of gel. The salt however has an adverse effect in the presence of iron oxide nanoparticles; and (4) Based on the amount of nanoparticles included with the current formulation these should be sufficient to generate heat of about 100° C.; thus, and all systems studied should form gels when heated magnetically.

Formation of Gel Employing Paramagnetic Nanoparticles and External Magnetic Oscillation. One way of generating an intense heat in a confined small volume is to employ superparamagnetic nanoparticles and external magnetic oscillations. The magnetic heating method, known as hyperthermia, is employed, e.g., only to burn off the cancerous cells while without affecting the neighboring living cells (Pollert and Zaveta, 2011). The potential application of the hyperthermia technique to generate heat only for a thin fluid layer in contact with the inner surface of oil/gas pipeline was recently investigated (Davidson et al., 2012). Heat generation studies for fluid samples that contain superparamagnetic nanoparticles as dispersion, and for inner surface coatings that have nanoparticles imbedded in them, demonstrated that a highly efficient heating of precisely confined areas is feasible with the technique.

A glass vial which contains a mixture of HPAM polymer, PEI crosslinker and paramagnetic nanoparticles was placed at the inner center of a three-turn magnetic coil, which generates a magnetic oscillation with frequency of 434 kHz. Three different solutions, as given in Table 15 below, are heated magnetically, and the approximate time taken for gel formation was recorded. For the system of 2000 ppm HPAM with 5 wt % PEI and 0.56 wt % of magnetic nanoparticles, gel formed after 40 minutes in the magnetic coil. Under the current of 16.2 A and 84 voltage, the solution generated high temperature very quickly. For the same solution with 0.5% NaCl, gel was formed after 4 hours because NaCl hinders the gel formation, as described before. For the same concentrations of polymer and PEI, but with 0.28 wt % of nanoparticles instead of 0.56 wt %, the temperature increase at the same exposure time was smaller. When the current was increased to 20.5 A, the temperature could be increased to 90° C., and gel formed after one hour.

TABLE 15

| | | |
|---|---|---|
| Magnetic power | | Time to gel |
| (frequency = 434 KHZ) | Temperature | formation |

(5 ml of 2000 ppm HPAM + 5% PEI) + 0.4 ml Fe₃O₄-NP

| | | |
|---|---|---|
| Current = 16.2 A, Voltage = 84 V | Extremely high | 40 min. |

(5 ml of 2000 ppm HPAM + 5% PEI + 0.5% NaCl) + 0.4 ml Fe₃O₄-NP

| | | |
|---|---|---|
| Current = 16.2 A, Voltage = 84 V | Extremely high | 4 hrs. |

(5 ml of 2000 ppm HPAM + 5% PEI) + 0.2 ml Fe₃O₄-NP

| | | |
|---|---|---|
| Current = 20.5 A, Voltage = 131 V | ~90° C. | 1 hr. |

The effect of different Fe₃O₄ nanoparticles concentration on the temperature increase was examined. Table 16 below lists the experimental results. Under the 5.7 A current, the solution containing 0.2 ml Fe₃O₄ nanoparticles could generate only 35° C.; whereas the solution which contains 0.4 ml Fe₃O₄ nanoparticles could generate 55° C. As the current was gradually increased, the corresponding temperature for both systems has been gradually increased. At the current setting of 13.5 A, the solution containing 2 ml Fe₃O₄ nanoparticles had 63° C.; whereas the solution containing 4 ml Fe₃O₄ nanoparticles was extremely hot. At 20.5 A current, the solution containing 2 ml Fe₃O₄ nanoparticles could raise the temperature to 90° C. and formed gel in one hour. (Note that 0.2 ml Fe₃O₄ nanoparticles is 0.28% by weight, and 0.4 ml is 0.56 wt %.).

The glass vial was placed at the center of the coil without any insulation. Therefore, some of the heat generated by the nanoparticles is dissipated through the sample container's wall by conduction and convection. The effects of such heat loss in raising the temperature of the sample mixture for gel formation have not been accounted for. In the future experiments, the sample container will be insulated, so that the heat generated by the nanoparticles is fully absorbed by the sample mixture in an adiabatic manner.

TABLE 16

| | Amount of NP | Temperature |
|---|---|---|
| Magnetic power | (in 5 ml of 2000 ppm | generated |
| (frequency = 434 kHZ) | HPAM + 5 wt % PEI) | (° C.) |
| Current = 5.7 A | 0.2 ml | 35 |
| Voltage = 5 V | 0.4 ml | 55 |
| Current = 9 A | 0.2 ml | 50 |
| Voltage = 21 V | 0.4 ml | 70 |
| Current = 13.5 A | 0.2 ml | 63 |
| Voltage = 54 V | 0.4 ml | Very high |
| Current = 20.2 A | 0.2 ml | 87 |
| Voltage = 128 V | 0.4 ml | Extremely high |
| Current = 20.7 A | 0.2 ml | 91 |
| Voltage = 133 V | 0.4 ml | Extremely high |
| Current = 20.5 A | 0.2 ml | 90 |
| Voltage = 131 V | 0.4 ml | Extremely high |

Time needed to form a gel from crosslinking of long-chain polymers with a crosslinker chemical was investigated as a function of temperature, pH and salinity. Three different polymers (partially hydrolyzed polyacrylamide, xanthan, and polyacrylamide modified with AMPS and NVP) and two different crosslinkers (chromium acetate, and PEI) were tested. In the presence of the iron oxide nanoparticles, while chromium acetate failed to serve as an effective crosslinker for all three polymers, PEI formed gels effectively with the polymers.

The time for gel formation increased with increase in salinity, and also in presence of Fe₃O₄ nanoparticles. Gel for 1% NaCl was obtained within a day, but not for 3% NaCl for many days.

Some preliminary experiments were carried out by subjecting the mixtures of HPAM polymer, PEI crosslinker and magnetic nanoparticles to hyperthermia heating by magnetic oscillation. The magnetic heating was efficient in raising temperature with the consequent gel formation. Fe₃O₄ nanoparticle concentration affects were examined as the temperature increase.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A method for enhanced oil recovery by improving reservoir volumetric sweep, comprising the steps of:
injecting into the wellbore a selective conformance control polymer solution with a viscosity that provides a much higher flow rate according to their permeability-thickness distribution into the high-permeability layer than into the low-permeability layer, wherein the selective conformance control polymer solution comprises one or more polymers, a crosslinking agent, and paramagnetic nanoparticles;
identifying the locations of the high-permeability layers by measuring the relative amount of paramagnetic nanoparticles in the reservoir layers, by way of the magnetic susceptibility measurement;
applying a magnetic field to the selective conformance control polymer solution to stimulate the paramagnetic nanoparticles to generate heat in the high-permeability layers;
crosslinking the one or more polymers and the crosslinking agent to form a selective conformance control gel to block the high-permeability layer; and
removing the un-crosslinked polymer from the low-permeability layers, so that they could serve as new flow pathways for the injected fluids or produced fluids that are diverted from the now blocked, high-permeability layers.

2. The method of claim 1, wherein the one or more polymers and crosslinking agent in the wellbore are below the critical temperature above which cross-linking occurs.

3. The method of claim 1, wherein the one or more polymers comprises polyacrylamide, hydrolyzed polyacrylamide, polyacrylamides with n-vinyl pyrrolidone (NVP) side chains, polyacrylamides with 2-acrylamido 2-methyl propane sulfonate (AMPS) side chains, polyacrylamides with NVP and AMPS side chains, polysaccharide, polyacryaltes, poly butyl acrylates, polysaccharides, methylcellulose, hydroxypropyl methylcellulose, curdlan, xanthan, or their combinations.

4. The method of claim 1, wherein the crosslinking agent comprises a metallic cross-linker, organic cross-linker or both.

5. The method of claim 1, wherein the crosslinking agent comprises polyethyleneimine, chromium acetate, aluminum citrate, sodium dichromate, and zirconium lactate.

6. The method of claim 1, wherein the nanoparticles used for heating are superparamagnetic nanoparticles.

7. The method of claim 1, wherein the paramagnetic nanoparticles comprise an iron oxide (Fe₃O₄, or magnetite) core.

8. The method of claim 1, wherein the paramagnetic nanoparticles are between 7 and 100 nm.

9. The method of claim 1, wherein the paramagnetic nanoparticles further comprises a hydrophilic coating, a hydrophobic coating or an intermediate-wettability coating.

10. The method of claim 1, wherein the magnetic field is applied using a magnetic oscillation generator.

11. The method of claim 1, wherein the magnetic field is a high frequency alternating magnetic field.

12. The method of claim 1, wherein the magnetic field provides an alternating frequency range of between about 300-1200 kHz.

13. The method of claim 1, wherein the magnetic field provides an alternating frequency range of about 390, 540, or 920 kHz.

14. The method of claim 1, further comprising the step of decomposing the selective conformance control gel by applying magnetic oscillation of the paramagnetic nanoparticles.

15. The method of claim 1, further comprising the step of decomposing the selective conformance control gel by thermal degradation induced by the paramagnetic nanoparticles.

16. The method of claim 1, further comprising the step of removing the uncrosslinked mixture from the unheated, low-permeability layer by a flow-back method.

17. The method of claim 1, wherein the paramagnetic nanoparticles function as a contrast agent allowing the identification of the high-permeability layer by detecting them with electromagnetic logging tools.

18. The method of claim 1, further comprising the step of imaging the high-permeability layer by detecting the paramagnetic nanoparticles with an electromagnetic logging tool.

19. The method of claim 1, further comprising the step of removing the magnetic field to release the polymer.

20. A method for enhanced oil recovery by improving reservoir volumetric sweep, comprising the steps of:
selecting a polymer and paramagnetic nanoparticles to make a control polymer solution for injection into the high-permeability layer than into the low-permeability layer depending on the temperature and pressure characteristics of a formation;
injecting into the wellbore a selective conformance control polymer solution with a viscosity that provides a much higher flow rate according to their permeability-thickness distribution into the high-permeability layer than into the low-permeability layer, wherein the selective conformance control polymer solution comprises one or more polymers, a crosslinking agent, and paramagnetic nanoparticles;
identifying the locations of the high-permeability layers by measuring the relative amount of paramagnetic nanoparticles in the reservoir layers, by way of the magnetic susceptibility measurement;
applying a magnetic field to the selective conformance control polymer solution to stimulate the paramagnetic nanoparticles to generate heat in the high-permeability layers;
forming a selective conformance control gel by self-crosslinking of one or more polymers to block the high-permeability layer; and
removing the un-crosslinked polymer from the low-permeability layers, so that they could serve as new flow pathways for the injected fluids or produced fluids that are diverted from the now blocked, high-permeability layers.

21. The method of claim 20, further including the step of releasing the magnetic field to release the polymer.
